(19) United States
(12) Patent Application Publication
(10) Pub. No.: US 2022/0108181 A1
(43) Pub. Date: Apr. 7, 2022

(54) ANOMALY DETECTION ON SEQUENTIAL LOG DATA USING A RESIDUAL NEURAL NETWORK

(71) Applicant: Oracle International Corporation, Redwood Shores, CA (US)

(72) Inventors: HAMED AHMADI, Burnaby (CA); SAEID ALLAHDADIAN, Vancouver (CA); MATTEO CASSERINI, Zurich (CH); MILOS VASIC, Zurich (CH); AMIN SUZANI, Vancouver (CA); FELIX SCHMIDT, Baden-Daettwil (CH); ANDREW BROWNSWORD, Vancouver (CA); NIPUN AGARWAL, Saratoga, CA (US)

(21) Appl. No.: 17/064,991

(22) Filed: Oct. 7, 2020

(51) Int. Cl. G06N 3/08; G06N 7/00

(52) U.S. Cl. CPC G06N 3/084; G06N 7/005

(57) ABSTRACT

A multilayer perceptron herein contains an already-trained combined sequence of residual blocks that contains a semantic sequence of residual blocks and a contextual sequence of residual blocks. The semantic sequence of residual blocks contains a semantic sequence of layers of an autoencoder. The contextual sequence of residual blocks contains a contextual sequence of layers of a recurrent neural network. Each residual block of the combined sequence of residual blocks is used based on a respective survival probability. By the autoencoder and based on the using each residual block of the semantic sequence, a previous entry of a log is semantically encoded. By the recurrent neural network and based on the using each residual block of the contextual sequence, a next entry of the log is predicted. In an embodiment during training, survival probabilities are hyperparameters that are learned and used to probabilistically skip residual blocks such that the multilayer perceptron has stochastic depth.

### RELATED CASE

Incorporated by reference in its entirety is related Oracle U.S. patent application Ser. No. 16/122,505, CONTEXT-AWARE FEATURE EMBEDDING AND ANOMALY DETECTION OF SEQUENTIAL LOG DATA USING DEEP RECURRENT NEURAL NETWORKS, filed Sep. 5, 2018 by Hossein Hajimirsadeghi et al.

### FIELD OF THE INVENTION

The present invention relates to deep learning for anomaly detection. Herein are training and inferencing techniques for predicting log entries based on an autoencoder and a recurrent neural network.

### BACKGROUND

A major security effort in activity log data analysis is intrusion detection, which is usually approached in industry using rule-based or signature-based techniques for discrete and deterministic pattern recognition. Recently, there have been attempts to use machine learning (ML) to overcome limitations of earlier approaches. ML techniques facilitate detecting novel anomalies, capturing complex anomalous patterns, and reducing security expert engagement. However, performance of ML techniques highly depends on model size and complexity as well as the richness and effectiveness of feature vectors that an ML model may accept as input for training and/or production inferencing.

Due to revolutionary advancements in deep learning, high-capacity anomaly detection models can be built to capture the inherent sequential nature of logged activity data. This is different from earlier models that work on individual log messages or simply aggregate information from multiple log messages by summing or averaging their features. However, deep learning models have their own challenges such as follows.

In order to learn more complex patterns, more neural layers must be added to a deep network. However, training more layers is not an easy task due to significantly increased training time and increased risk of over-fitting.

The vanishing gradient problem also is a notorious impediment to training deep networks. When using gradient-based learning techniques to train an artificial neural network, each of the neural network's many connection weights are updated proportional to a partial derivative of an error function with respect to a current connection weight. A problem with deep networks is, due to repeated multiplication with coefficients, gradients become so small in early layers near original input that connection weights prematurely converge and cease updating (i.e. learning). Thus, a deep network having more layers could potentially yield a less accurate result, which is counter intuitive.

There also is a design tension between: a) too many neural layers that causes vanishing gradients in a backward direction such as with backpropagation and b) a diminishing feature reuse problem (also known as loss in information flow) which is similar to vanishing gradients but in the forward direction such as during feed-forward training. During training and/or hyperparameter optimization, known approaches fail to discover an optimal neural layering topology that balances vanishing gradients and loss in information flow to maximize training accuracy and minimize training time such as taught herein.

### BRIEF DESCRIPTION OF THE DRAWINGS

In the drawings:

FIG. 1 is a block diagram that depicts an example computer that respectively weights residual blocks to increase accuracy of a next entry of a log as predicted by an already-trained multilayer perceptron (MLP) such as for anomaly detection;

FIG. 2 is a flow diagram that depicts an example prediction process that a computer may perform by using an already-trained multilayer perceptron to predict a next entry in a log;

FIG. 3 is a flow diagram that depicts an example stochastic training process that a computer may perform to probabilistically train a multilayer perceptron to predict a next entry in a log;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview a deep network architecture that uses residual blocks of neural layers to overcome topological problems such as vanishing gradients and loss in information flow. Deep networks herein operate as an end-to-end network that performs both feature encoding and anomaly detection at a same time, which is not a typical approach. Approaches herein train a recurrent neural network (RNN) with residual blocks and sequences of log messages in order to perform both feature embedding and anomaly detection in one model.

Deep networks herein are composed of a reconstruction model for training and a prediction model that is equipped with residual blocks of neural layers. By including these residual blocks, a deep network is more capable than a unified embedded RNN (UEMRNN) due to faster training and more accurate capture of more complex relations in data from log traces.

Deep networks herein can be used for security applications in activity log analytics such as intrusion detection or log data monitoring and pattern recognition, such as for surveillance of enterprise and public cloud activity. Log data analysis also has numerous uses in internet of things (IoT) for fault detection and/or security monitoring. In other words, robustness such as reliability, availability, and serviceability (RAS) of an online ecosystem may be increased due to thorough and early detection of anomalies by a deep network whose accuracy is increased by incorporating residual blocks as taught herein. Segmenting an RNN into residual blocks provides better attack detection and less false positives.

A deep model provides a high-capacity model which can fit to a large volume of training data and improve detection results. Included within the deep model are an RNN model and an autoencoder model. The RNN model suits the inherent sequential nature of log data. Feature embedding by the autoencoder model provides more generalization of input samples and denser semantic feature vectors such as discussed herein. Such improved feature extraction and encoding reduces computational complexity of the entire deep network. Because residual blocks mitigate problems associated with having too many neural layers, network depth can be increased to facilitate recognition of more numerous and more diverse log data patterns without increasing training time nor decreasing training accuracy.

Herein a deep network is a multilayer perceptron. In an embodiment into a multilayer perceptron such as in volatile memory, a computer loads an already-trained combined sequence of residual blocks that contains a semantic sequence of residual blocks and a contextual sequence of residual blocks. A semantic sequence of layers of an autoencoder are loaded into the semantic sequence of residual blocks. A contextual sequence of layers of a recurrent neural network are loaded into the contextual sequence of residual blocks. Each residual block of the combined sequence of residual blocks is used based on a respective survival probability. By the autoencoder and based on the using each residual block of the semantic sequence, a previous entry of a log is semantically encoded. By the recurrent neural network and based on the using each residual block of the contextual sequence, an encoding of a next entry of the log is predicted.

In an embodiment, actual and predicted encodings of next entries of the log are compared to detect a mismatch that indicates an anomaly. In an embodiment, the multilayer perceptron can detect an anomaly in real time such as in a live activity log of a production software application or network element such as a router. In an embodiment, the multilayer perceptron receives the live activity log as a continuous stream, and/or the multilayer perceptron is embedded in the network element or embedded in a telemetry server for IoT.

In an embodiment during training, survival probabilities are hyperparameters that are used to probabilistically skip residual blocks such that the multilayer perceptron has stochastic depth. In an embodiment, survival probabilities are learned or otherwise mathematically optimized. For example, survival probabilities can be tuned as hyperparameters with respect to the loss function of the multilayer perceptron such as with gradient-based hyperparameter tuning.

### 1.0 Example Computer

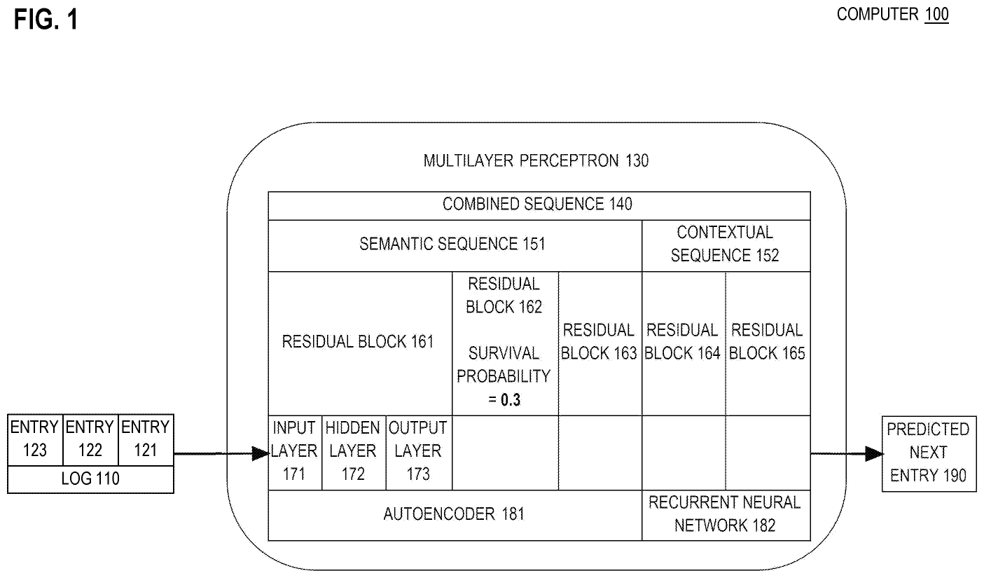

FIG. 1 a block diagram that depicts an example computer 100, in an embodiment. In production, computer 100 respectively weights residual blocks 161-165 to increase accuracy of next entry 190 of log 110 as predicted by already-trained multilayer perceptron (MLP) 130 such as for anomaly detection as follows.

Offline or in real time, computer 100 inspects entries 121-123 of log 110 to detect an anomalous entry such as for detecting a malfunction or malicious activity. In various embodiments, log 110 is content of a continuous stream, a persistent file, or a memory buffer. Log 110 may contain a physical, logical, and/or temporal sequence of many log entries such as 121-123.

For example, log 110 may be console output of a software process such as standard output (stdout) such as generated by computer 100, another computer, a network element such as a router, or a remote sensor that streams telemetry such as for an internet of things (IoT). In various embodiments, entries 121-123 contain textual data, binary data, or both. For example, entries 121-123 may be respective adjacent lines of text in a log file such as separated by carriage returns or null terminators.

In some cases, computer 100 can detect that a log entry such as 123 is, by itself, anomalous. In other cases as follows, computer 100 detects that log entry 123 is anomalous when preceded by log entries 121-122, even though entry 123 might not have been anomalous if preceded by other log entries or none. In other words, computer 100 detects a contextual anomaly.

Computer 100 delegates anomaly detection to multilayer perceptron 130 that is already trained in this example such as discussed later herein. Multilayer perceptron 130 may be an artificial neural network (ANN) model composed of a sequence of interconnected neural layers, including 171-173, that when activated together can infer predicted next log entry 190 as discussed below.

Multilayer perceptron 130 contains a hierarchical structure as shown and as follows. Multilayer perceptron 130 contains combined sequence 140 of many residual blocks such as 161-165 as explained later herein. Each residual block contains a sequence of one or more neural layers. For example, residual block 161 contains, in sequence, neural layers 171-173.

Each layer contains many neurons that each integrates many inputs to generate a respective output such as according to an activation function as explained later herein. In an embodiment, each neural layer is fully connected to its at most two adjacent layers. For example, all outputs of input layer 171 are used as inputs of hidden layer 172. Likewise, all outputs of hidden layer 172 are used as inputs of output layer 173.

Full connectivity between two layers means that output of all neurons of a previous layer are provided as input to all neurons of a next layer. For example, if input layer 171 has a thousand neurons, then each neuron of hidden layer 172 receives a same thousand inputs. However, each input is individually weighted or scaled by each receiving neuron such that each receiving neuron contains a thousand trainable weights with which to respectively scale the thousand inputs.

Two neurons in a same next layer may have different weights for a same input. For example, connecting a thousand neurons in a previous layer to another thousand neurons in a next layer needs 1,000×1,000=a million trainable connection weights. Neurons in a same layer are not connected to each other nor to neurons in non-adjacent layers.

As explained above, each residual block contains a sequence of layers. Adjacent layers are connected in a way that depends on whether or not they reside in same or different residual blocks. As described later herein, output of output layer 173 in previous residual block 161 is used in a special way as input by a next layer (not shown) in next residual block 162. In that sense, a flow from left to right of activation data through the sequence of all layers of multilayer perceptron 130 also is a flow of activation data through combined sequence 140 that contains, in sequence, residual blocks 161-165.

As such, a residual block is connected to at most two adjacent residual blocks. For example, all outputs of residual block 161 are used as inputs of residual block 162. Likewise, all outputs of residual block 162 are used as inputs of residual block 163. Specifically, the last neural layer of a previous residual block is connected to the first neural layer of a next residual block, but in a special way as described later herein.

Forecasting how many neural layers in multilayer perceptron 130 would be optimal is more or less intractable, especially because too few or too many layers degrades performance by reducing the accuracy of predicted next entry 190 and/or increasing training time of multilayer perceptron 130. No matter how many layers does multilayer perceptron 130 contain, some layers are more important than others for accurate prediction of next entry 190, and some layers can reduce prediction accuracy. To compensate for the varied impact of various layers on prediction accuracy, multilayer perceptron 130 weights contributions by residual blocks 161-165 according to respective survival probabilities.

Each residual block has its own trainable survival probability. In an embodiment, survival probability is proportional to the residual block's beneficial effect on prediction accuracy. In an embodiment, a survival probability is a real number such as floating point that is normalized within a range of zero to one, such that with regards to effecting prediction accuracy: one indicates a maximally beneficial layer; zero indicates a maximally harmful layer; and 0.5 indicates a maximally insignificant layer. For example as shown, 0.3 is the survival probability of residual block 162 as learned during training as discussed later herein. In an embodiment, survival probabilities can be tuned as hyperparameters with respect to the loss function of multilayer perceptron 130 such as with gradient-based hyperparameter tuning. In an embodiment, mathematics of survival probabilities are as follows.

The following explanation is based on three adjacent residual blocks such as 161-163 as follows. As explained earlier herein, output of a last layer of residual block 162 is used as input of a first layer of residual block 163, but with adjustment according to the survival probability of 0.3 of residual block 162 as follows. With such an adjustment, what residual block 163 receives as input is not exactly the output of the last layer of residual block 162, but instead a weighted summation, according to the survival probability of residual block 162, of: the output of the last layer of residual block 162 and the output of residual block 161.

Output of a layer is a vector of numbers that respectively represent scalar output of each neuron of the layer. Output of a residual block 162 is based on addition of: the output vector of the last layer of residual block 162 and the output vector of residual block 161. When both of those output vectors have a same length, vector addition produces a new vector of the same length in which each scalar at a distinct offset is a weighted sum of respective scalars at the same offset in each of those output vectors. When one vector is too short, it can be extended with additional zeroes or 0.5's to match the length of the other vector.

More specifically, the weighted sum is the scalar output of neuron of the last layer of residual block 162 plus a weighted corresponding scalar of the output vector of residual block 161. Weighting entails multiplying the scalar of the output vector of residual block 161 by the survival probability of residual block 162. Thus, all scalars in the output vector of residual block 161 are weighted by 0.3.

A survival probability of 0.5 causes averaging such that both vectors being combined contribute equally to generating the output of residual block 162. A survival probability of zero causes the output vector of residual block 161 to be used as a complete replacement of the output of the last layer of residual block 162, as if residual block 162 and all of its layers were absent and as if residual blocks 161 and 163 were instead directly connected to each other. In other words, when the survival probability of residual block 162 is zero, residual block 162 is effectively skipped, thereby reducing how many layers does multilayer perceptron 130 use.

A survival probability of one causes residual block 162 to behave as if its layers were not contained in a residual block, which is to say that the output of the last layer of residual block 162 is directly used as the input of residual block 163. In those ways, the contribution of each residual block is weighted to reflect the importance of the residual block. Thus, an inability to accurately forecast how many layers should multilayer perceptron 130 have can be compensated for by having too many layers and partially skipping by low weighting residual blocks that contain more or less unimportant layers as already detected and learned in training. Although more layers can somewhat interfere with backpropagation, this can be remediated by using the survival probabilities in a different way during training as discussed later herein.

In an embodiment, the input to a next residual block is adjusted according to the following formula where Y(x) is the output of the current residual block before activation function, x is the output of a previous residual block, F(x) is the output of the current residual block, W is the connection weight matrix, pₗ is a skipping probability that is 1—survival probability of the current residual block, according to this formula: Y(x)=pₗ. F(x)+W.x

As discussed above, multilayer perceptron 130 and its combined sequence 140 of residual blocks may seem somewhat homogenous. However, the following additional architectural configurations are also involved, which means that some layers and residual blocks may be very different from others in same multilayer perceptron 130. Multilayer perceptron 130 is bipartite because combined sequence 140 has subsequences 151-152 that have different architectures as discussed below. For example as shown, adjacent residual blocks 163-164 are architecturally dissimilar because they are part of dissimilar respective subsequences 151-152. In an embodiment and despite such dissimilarity, the survival probability of residual block 164 is used to weight the output of dissimilar residual block 163 as discussed above.

Multilayer perceptron 130 contains autoencoder 181 and recurrent neural network (RNN) 182, both of which are themselves separately specialized lesser multilayer perceptrons that are connected together such that output of autoencoder 181 is provided as input of recurrent neural network 182. Thus, lesser multilayer perceptrons 181-182 cooperate to predict next entry 190 as follows.

Lesser multilayer perceptrons 181-182 may have extremely different architectures because they have separate purposes. The purpose of autoencoder 181 is to recognize semantics of each of log entries 121-123 individually. Here individually means that, at any moment, autoencoder 181 contains data derived from only one log entry.

In other words, autoencoder 181 extracts semantic features of a log entry in isolation and regardless of which log entries are adjacent to it in log 110. In some ways, autoencoder 181 acts as a transcoder of semantic features of a log entry from the entry's original format into a natural vocabulary that emerges within autoencoder 181 during training. That is, output of autoencoder 181 is that internal vocabulary, which recurrent neural network 182 consumes as follows. Examples of semantic features and their recognition and encoding by an autoencoder are presented in related Oracle U.S. case Ser. No. 16/122,505.

Autoencoder 181 contains semantic sequence 151 of residual blocks 161-163 that contain neural layers. The output of residual block 163 also is the output of semantic sequence 151, which also is the output of autoencoder 181. That output is a neural encoding of relevant semantic features of a log entry, which is used as input to recurrent neural network 182.

Recurrent neural network 182 contains contextual sequence 152 of residual blocks 164-165 that contain neural layers. The input of residual block 164 also is the input of contextual sequence 152, which also is the input of recurrent neural network 182. That input is received as output from autoencoder 181 and processed as follows.

Unlike autoencoder 181 that processes one log entry in isolation, recurrent neural network 182 contains a pipeline of stages (not shown) that each processes a distinct respective log entry at a same time. The pipeline and its stages cooperate as follows.

So-called deep learning is based on a multilayer perceptron, such as recurrent neural network 182, having a multitude of layers that confers depth. In that sense, a count of layers is a measurement of depth, which is one dimension. In some ways, recurrent neural network 182 may be considered a two-dimensional array of neurons, with multiplicity of layers as depth being one of the dimensions.

The other dimension is the scale of a layer, which is the amount of neurons in the layer. Thus when recurrent neural network 182 has a hundred layers that each have a thousand neurons, recurrent neural network 182 may be a 100×1,000 array of neurons. Although neural activation of a generic multilayer perceptron propagates only between layers, recurrent neural network 182 also interconnects neurons of a same layer such that activation can additionally propagate between neurons within a same layer.

Neural stages of the pipeline of recurrent neural network 182 are topologically orthogonal to the layers of recurrent neural network 182. That is, each stage contains portions of all layers of recurrent neural network 182. Likewise, each layer contains portions of all stages of recurrent neural network 182. Likewise, each stage contains portions of residual blocks 164-165. Likewise, each of residual blocks 164-165 contains portions of all stages.

The neural stages of recurrent neural network 182 operate as follows. At a same time, each stage processes a distinct respective log entry. That is at a same time, recurrent neural network 182 simultaneously processes as many log entries as recurrent neural network 182 has stages.

For example when recurrent neural network 182 has two stages, recurrent neural network 182 can simultaneously process log entries 121-122 to generate next entry 190 that more or less accurately predicts log entry 123. In another example, recurrent neural network 182 instead contains six stages and simultaneously processes six log entries. The pipeline operates somewhat like a shift register such that each time autoencoder 181 provides another semantically-encoded log entry, the other log entries already in the pipeline are shifted by one stage to make room for the additional log entry.

That shifting causes an oldest log entry to be shifted out of the pipeline and discarded. Thus, recurrent neural network 182 operates as an analytic window of a fixed amount of log entries, and the window effectively slides over the contents of log 110. Thus, recurrent neural network 182 can analyze a small subsequence of log entries together as a unit.

Thus, recurrent neural network 182 can analyze both of the already-encoded semantics of a log entry as well as the positional context of that log entry as embedded within a small neighborhood of adjacent log entries. In other words, recurrent neural network 182 recognizes familiar patterns for neighboring log entries. Thus by recognizing a particular sequential pattern, recurrent neural network 182 can predict next log entry 190.

If predicted next entry 190 does not match actual next entry 123, then an anomaly may be detected, which may be recorded as a noteworthy occurrence and/or alerted as problematic such as malicious. In an embodiment, matching does not entail direct comparison of next entries 123 and 190, but instead entails comparing neural encodings of next entries 123 and 190 as generated by autoencoder 181. For example, recurrent neural network 182 may perform such comparison of neural encodings. Thus in an embodiment, recurrent neural network 182 itself detects an anomaly.

For example and in any case, log 110 may be a traffic log of an internet router, and a detected anomaly may indicate a possible network intrusion. In a so-called offline embodiment, log 110 is historical, and recurrent neural network 182 contextually analyzes log 110 to detect an anomaly that occurred in the past.

In an embodiment, log 110 is a live stream such as containing network traffic data and/or metadata, and recurrent neural network 182 almost instantaneously detects an anomaly such as a network intrusion. Thus, recurrent neural network 182 is well suited for real time use. For example, multilayer perceptron 130 may be embedded in a network router.

The architecture of multilayer perceptron 130 may scale to contain many more: a) residual blocks in subsequence 151 and/or 152, and b) hidden neural layers such as 172 in some or all of residual blocks 161-165. In a more practical embodiment not shown, contextual sequence 152 has more neural layers in more residual blocks than does semantic sequence 151. Indeed, the more residual blocks and/or neural layers does multilayer perceptron 130 have, the more important may be the survival probabilities of the residual blocks. For example, survival probabilities may compensate for an overabundance of residual blocks and/or neural layers that otherwise would reduce training accuracy and/or increase training time.

### 2.0 Example Production Inferencing Process

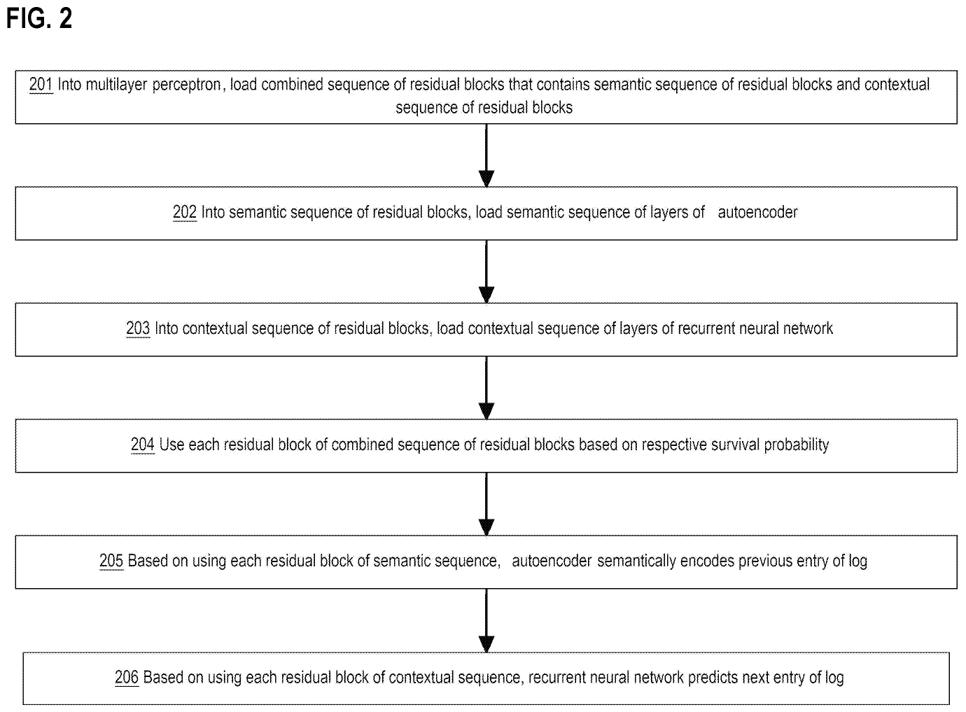

FIG. 2 is a flow diagram that depicts an example prediction process that computer 100 may perform by using already-trained multilayer perceptron 130 to predict next entry 190 in log 110 such is in a production environment. FIG. 2 is discussed with reference to FIG. 1.

The process of FIG. 2 occurs in two phases. Loading steps 201-203 are preparatory and load multilayer perceptron 130 such as into volatile memory. Inferencing steps 204-206 occur while multilayer perceptron 130 is inferring from a production stimulus such as with either a live or offline deployment.

Into multilayer perceptron 130, step 201 loads combined sequence 140 of residual blocks 161-165 that contains semantic sequence 151 of residual blocks 161-163 and contextual sequence 152 of residual blocks 164-165. In various embodiments, some or all of loading steps 201-203 are combined such as when steps 202-203 are sub-steps of step 201. In any case, loading into multilayer perceptron 130, a residual block such as 151, and/or a neural layer such as 171 may entail loading connection weights and/or survival probabilities into volatile memory such as follows.

For example, weights and/or probabilities may be coefficients that may be bulk loaded such as from a file and into a numeric matrix. In an embodiment based on the Keras neural network library, a python script may load coefficients of multilayer perceptron 130, a residual block such as 151, and/or a neural layer such as 171 into respective matrices. Connection weights and survival probabilities are functionally different and may be segregated into separate respective matrices.

Into semantic sequence 151 of residual blocks 161-163, step 202 loads neural layers 171-173 of autoencoder 181 such as with coefficient matrix loading as discussed above. In an embodiment, all neural layers of autoencoder 181 are loaded as a lesser multilayer perceptron as discussed earlier herein such as into a single matrix. In an embodiment, each of residual blocks 161-163 is loaded as a respective lesser multilayer perceptron into a respective matrix.

Into contextual sequence 152 of residual blocks, step 203 loads contextual sequence 152 of neural layers of recurrent neural network 182 such as with coefficient matrix loading as discussed above. In an embodiment, all neural layers of recurrent neural network 182 are loaded as a lesser multilayer perceptron as discussed earlier herein such as into a single matrix. In an embodiment, each of residual blocks 164-165 is loaded as a respective lesser multilayer perceptron into a respective matrix.

When step 203 finishes, multilayer perceptron 130 is fully loaded such as within volatile memory and is ready for production inferencing. In this example, multilayer perceptron 130 has already processed log entry 121 and is currently processing log entry 122 as follows. Steps 205-206 may be sub-steps of step 204.

Step 204 uses each residual block 161-165 of combined sequence 140 based on respective survival probabilities of the residual blocks. All of the neural layers of combined sequence 140 may process log entry 122. However, a survival probability of each residual block may increase or decrease the importance of the residual block by weighting as described earlier herein.

Based on using each residual block 171-173 of semantic sequence 151 in step 205, autoencoder 181 semantically encodes log entry 122 such as discussed earlier herein. Features of log entry 122 may be extracted by parsing log entry 122 into a feature vector that is sparsely encoded. For example, a categorical feature such as a city or county may be one-hot encoded into a bitmap or array of integers or Booleans.

Residual block 161 accepts the sparse feature vector as input. Semantic encoding by semantic sequence 151 entails dense neural encoding such as presented in related Oracle U.S. case Ser. No. 16/122,505. Output of residual block 163 is the dense neural semantic encoding of log entry 122.

Based on using each residual block 164-165 of contextual sequence 152 in step 206, recurrent neural network 182 predicts next log entry 123. Contextual sequence 152 simultaneously contextually analyzes both of neutrally encoded log entries 121-122 during step 206 with pipeline stages discussed earlier herein. Contextual analysis depends on data sequence.

For example as shown, log entry 121 occurring before log entry 122 causes different contextual analysis than if log entry 122 instead occurs before log entry 121. In other words, output of residual block 165 depends on which ordering do log entries 121-122 occur. Thus, contextual sequence 152 recognizes temporal patterns such as activity scenarios that semantic sequence 151 cannot recognize.

For example, log entry 123 may be recognized as anomalous based on comparison to predicted next entry 190 even though log entry 123 by itself or in other scenarios would not be anomalous. For example, log entry 123 may be anomalous only when preceded by log entry 121 or 122 or both. For example, log entry 123 may be anomalous when preceded by only one of log entries 121-122 but not both. Conversely, log entry 123 may be anomalous when preceded by both log entries 121-122, but not if preceded by only one of log entries 121-122. Likewise, log entry 123 may be anomalous when log entry 121 precedes log entry 122, but not anomalous if log entry 122 precedes log entry 121.

As discussed earlier herein, recurrent neural network 182 operates a sliding window of adjacent log entries that facilitates sequential pattern recognition of varied specificity such as follows. For example, contextual sequence 152 can recognize a precise sequence of log entries that fills the window, or a precise subsequence anywhere within the window or precisely situated within the window. For example, a window of three log entries may have same or different contextual analysis depending on whether a subsequence of two adjacent log entries occur at the start or end of the current window contents.

Likewise a relative ordering of log entries, instead of a precise subsequence, can be recognized. For example, a window that contains more than two log entries may detect whether one particular log entry relatively precedes another particular log entry, even when both log entries are not adjacent because at least one other log entry occurs between those two log entries. Likewise, contextual sequence 152 can recognize that a particular log entry occurs anywhere within the window or precisely situated within the window.

### 2.0 Example Training Process

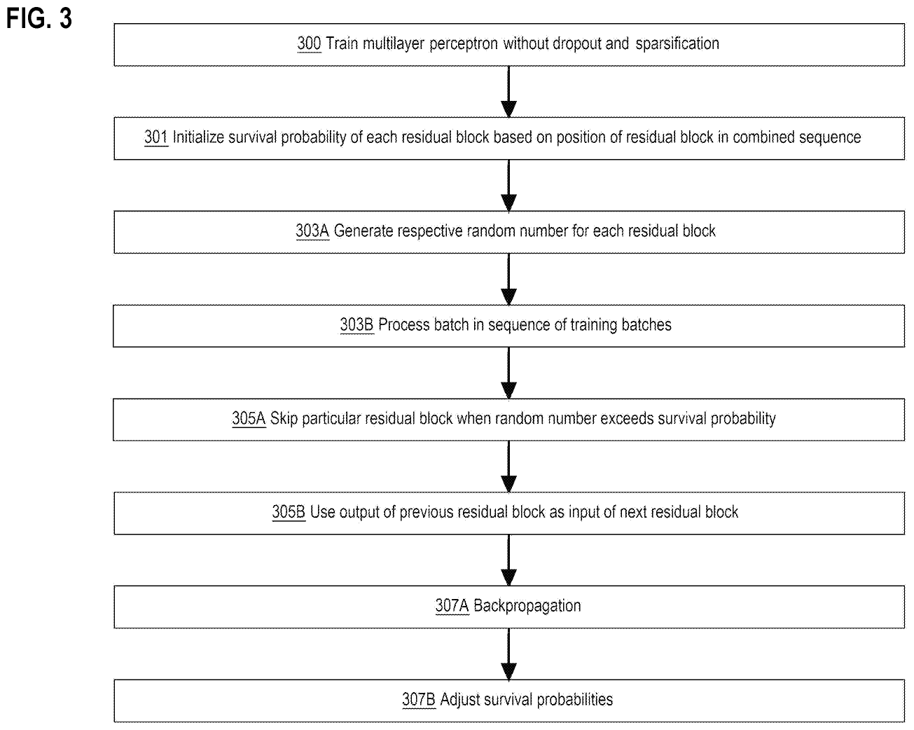

FIG. 3 is a flow diagram that depicts an example stochastic training process that computer 100 may perform to probabilistically train multilayer perceptron 130 to predict next entry 190 in log 110. FIG. 2 is discussed with reference to FIG. 1. Stochastic training occurs during step 300 that may include the remaining steps of FIG. 3 as sub-steps as follows. Various embodiments may or may not include various steps of FIG. 3.

Step 300 trains multilayer perceptron 130 without dropout nor sparsification. Other techniques need dropout and/or sparsification for efficiency. Training herein does not need dropout nor sparsification but some embodiments may include dropout and/or sparsification. Sparsification is permanent removal of neurons and/or connections between neurons when they become more or less mathematically insignificant, such as when a weight of a connection approaches zero or when a sum of output connection weights of a neuron approaches zero, such as at the end of training or at various times during training. Dropout is temporary removal and subsequent restoration of random subset of neurons at various times during training. Dropout and/or sparsification may or may not be obsolete based on survival probabilities herein.

Step 301 initializes survival probabilities of all residual blocks 161-165 based on each residual block's position in combined sequence 140. In an embodiment, an initial survival probability of any residual block is inversely proportional to the distance of the residual block from combined sequence 140's first residual block 161 such that last residual block 165 has a lowest initial survival probability. In an embodiment, initial survival probabilities in semantic sequence 151 are higher than initial survival probabilities in contextual sequence 152. In an embodiment, initial survival probabilities are inversely proportional to distance from a first residual block 161 or 164 in a respective subsequence 151 or 152 such that initial survival probability of residual block 164 is higher than initial survival probability of residual block 163, but initial survival probability of residual block 164 may or may not be less than initial survival probability of residual block 161. Adjusting survival probabilities after initialization is discussed later herein.

In an embodiment within combined sequence 140 or subsequence 151 or 152, initial survival probabilities decrease linearly by distance as discussed above such as according to a formula such as:

$${P}_{l} = 1 - \frac{l}{L} ( 1 - {P}_{L} ) ,$$

where L is the total number of residual blocks in the sequence or subsequence and P_{L} is a constant hyperparameter. As such, earlier layers that produce low-level features are more likely to survive and provide necessary information for the later layers. Depending on the magnitude of P_{L}, much time may be saved during training.

A training corpus of training samples may be subdivided into training batches. Steps 303A-B may occur for each batch such as follows. For example, a sequence of batches may be iterated to repeatedly change which batch is a current batch.

Step 303A generates a respective random number for each residual block 161-165 for the current batch such as a normalized number from zero to one. Step 303B feed-forward processes the current batch through multilayer perceptron 130. Step 303B may include steps 305A-B as sub-steps as follows.

Unlike inferencing as with FIG. 2 that uses a survival probability for weighting, training step 305A instead skips a particular residual block whose survival probability exceeds the residual block's random number of step 303A. Because residual block 162 has a survival probability of 0.3, residual block 162 is likely to be skipped for seventy percent of training batches. Skipping current residual block 162 causes, in step 305B, previous residual block 161's output to be directly used as next residual block 163's input as if residual blocks 161 and 163 were directly connected. A residual block might be skipped for a previous batch and not skipped for a next batch or vice versa.

When residual block 162 is not skipped, neural layers of residual block 162 behave as if those neural layers were not contained in a residual block such that those neural layers process output of residual block 161 to generate output that is used as input for residual block 163. An effect of probabilistic skipping of residual blocks during training is that multilayer perceptron 130 contains a stochastically determined subset of residual blocks 161-165 and thus a stochastic amount of neural layers that changes between each batch.

In various embodiments and as described later herein, backpropagation occurs in step 307A after each one or fixed amount of training batches or after each training sample in a batch. Backpropagation is a mathematical optimization that adjusts connection weights to increase accuracy such that connections that currently increase accuracy have their weights increased, and connections that currently decrease accuracy have their weights decreased. Backpropagation may affect survival probabilities as follows.

Regardless of backpropagation, survival probabilities are hyperparameters that may be mathematically optimized such as by dynamic adjustment during training such as between training batches. In an embodiment, step 307B adjusts survival probabilities during backpropagation to increase accuracy such that residual blocks whose output currently increases accuracy have their survival probabilities increased, and residual blocks whose output currently decreases accuracy have their survival probabilities decreased.

In an embodiment, a residual block that is not skipped and that currently does not affect accuracy will not have its survival probability adjusted at the end of the current batch. For example, the residual block's survival probability may have converged on optimality. In an embodiment, a residual block that is skipped will not have its survival probability adjusted at the end of the current batch.

As explained above, survival probabilities may or may not be adjusted during training. In an embodiment, those survival probabilities are used as is in production as explained earlier herein. In another embodiment at the end of training, those survival probabilities are discarded and replaced with new survival probabilities that are based on a percentage of times in training that a respective residual block was not skipped.

As explained earlier herein, autoencoder 181 acts as a transcoder of semantic features of a log entry from the entry's original format into a natural vocabulary that emerges within autoencoder 181 during training. Training of autoencoder 181 may be accelerated by expressly validating autoencoder 181's emergent internal neural vocabulary such as follows. In an embodiment and only during training, multilayer perceptron 130 contains an additional lesser multilayer perceptron that is an autodecoder that reverse transcodes the output of autoencoder 181 in an attempt to reconstruct the feature vector input of autoencoder 181.

Training accuracy of autoencoder 181 may be measured by comparing such original and reconstructed feature vectors. Backpropagation in autoencoder 181 may be based on such training accuracy of autoencoder 181 as empirically measured through autodecoding as architected and presented in related Oracle U.S. patent application Ser No. 16/122,505.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

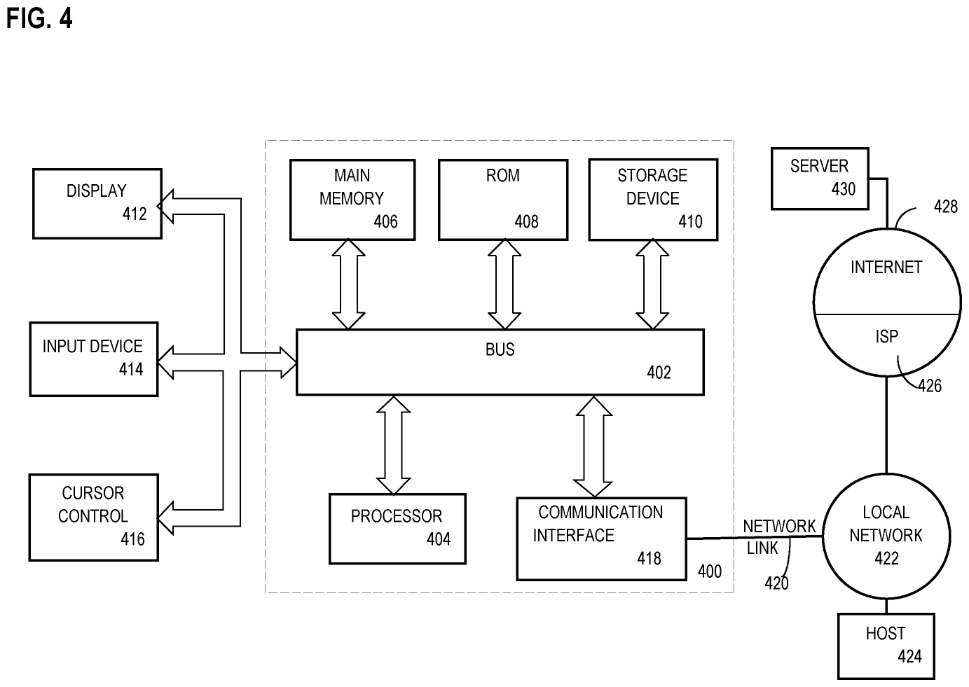

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that facilitates the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

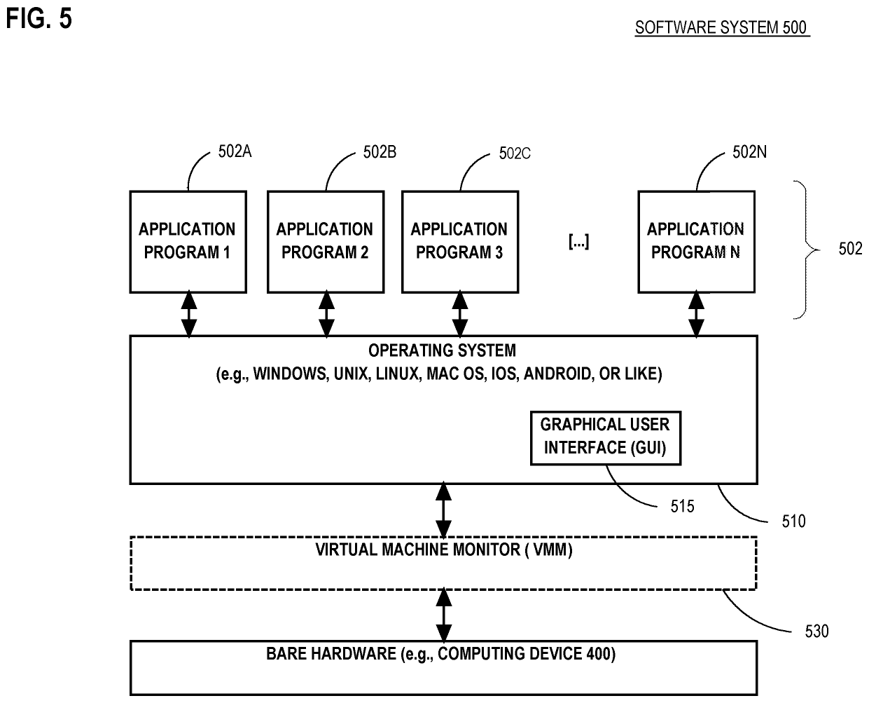

FIG. 5 is a block diagram of a basic software system 500 that may be employed for controlling the operation of computing system 400. Software system 500 and its components, including their connections, relationships, and functions, are meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may facilitate a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which facilitates for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programming languages including C#, Ruby, Lua, Java, MatLab, R, and Python.

### Artifical Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is the adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in non-patent literature (NPL) “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
loading, into a multilayer perceptron, a combined sequence of residual blocks that contains a semantic sequence of residual blocks and a contextual sequence of residual blocks;
loading, into the semantic sequence of residual blocks, a semantic sequence of layers of an autoencoder;
loading, into the contextual sequence of residual blocks, a contextual sequence of layers of a recurrent neural network;
using each residual block of the combined sequence of residual blocks based on a respective survival probability;
semantic encoding, by the autoencoder and based on said using said each residual block of said semantic sequence, a previous entry of a log;
predicting, by the recurrent neural network and based on said using said each residual block of said contextual sequence, a predicted next entry of the log.

2. The method of claim 1 further comprising:
comparing said predicted next entry of the log to an actual next entry of a log;
detecting, based one said comparing said next entries, that said actual next entry is anomalous.

3. The method of claim 1 wherein said using said each residual block of the combined sequence comprises weighted summation, based on said survival probability of the residual block, of:
input of an input layer of the residual block, and
output of an output layer of the residual block.

4. The method of claim 3 wherein:
said combined sequence of residual blocks contains, in sequence, a previous residual block, a particular residual block, and a next residual block;
the method further comprises:
using output of said previous residual block as input of the particular residual block, and
using output of said particular residual block as input of said next residual block.

5. The method of claim 4 wherein:
a particular sequence of residual blocks that contains said particular residual block is said semantic sequence of residual blocks or said contextual sequence of residual blocks;
said particular sequence of residual blocks further contains one or zero residual blocks selected from: said previous residual block and said next residual block.

6. The method of claim 1 further comprising adjusting said survival probabilities of said combined sequence of residual blocks while training said multilayer perceptron.

7. The method of claim 6 wherein said training said multilayer perceptron comprises:
generating a respective random number for each residual block of said combined sequence;
skipping a particular residual block of said combined sequence of residual blocks when said random number of said particular residual block exceeds said survival probability of said particular residual block.

8. The method of claim 7 wherein:
said combined sequence of residual blocks contains, in sequence, a previous residual block, said particular residual block, and a next residual block;
said skipping said particular residual block comprises using output of said previous residual block as input of said next residual block.

9. The method of claim 7 wherein said generating said random number for each residual block occurs before each batch of a sequence of training batches.

10. The method of claim 6 wherein said training said multilayer perceptron comprises no training technique selected from: dropout and sparsification.

11. The method of claim 6 further comprising during said training, initializing said survival probability of each residual block of said combined sequence based on a position of the residual block in said combined sequence.

12. The method of claim 6 wherein said adjusting said survival probabilities of said combined sequence occurs during backpropagation.

13. One or more non-transitory computer-readable media storing instructions that, when executed by one or more processors, cause:
loading, into a multilayer perceptron, a combined sequence of residual blocks that contains a semantic sequence of residual blocks and a contextual sequence of residual blocks;
loading, into the semantic sequence of residual blocks, a semantic sequence of layers of an autoencoder;
loading, into the contextual sequence of residual blocks, a contextual sequence of layers of a recurrent neural network;
using each residual block of the combined sequence of residual blocks based on a respective survival probability;
semantic encoding, by the autoencoder and based on said using said each residual block of said semantic sequence, a previous entry of a log;
predicting, by the recurrent neural network and based on said using said each residual block of said contextual sequence, a predicted next entry of the log.

14. The one or more non-transitory computer-readable media of claim 13 wherein the instructions further cause:
comparing said predicted next entry of the log to an actual next entry of a log;
detecting, based one said comparing said next entries, that said actual next entry is anomalous.

15. The one or more non-transitory computer-readable media of claim 13 wherein said using said each residual block of the combined sequence comprises weighted summation, based on said survival probability of the residual block, of:
input of an input layer of the residual block, and
output of an output layer of the residual block.

16. The one or more non-transitory computer-readable media of claim 15 wherein:
said combined sequence of residual blocks contains, in sequence, a previous residual block, a particular residual block, and a next residual block;
the instructions further cause:
using output of said previous residual block as input of the particular residual block, and
using output of said particular residual block as input of said next residual block.

17. The one or more non-transitory computer-readable media of claim 13 wherein the instructions further cause adjusting said survival probabilities of said combined sequence of residual blocks while training said multilayer perceptron.

18. The one or more non-transitory computer-readable media of claim 17 wherein said training said multilayer perceptron comprises:
generating a respective random number for each residual block of said combined sequence;
skipping a particular residual block of said combined sequence of residual blocks when said random number of said particular residual block exceeds said survival probability of said particular residual block.

19. The one or more non-transitory computer-readable media of claim 17 wherein the instructions further cause during said training, initializing said survival probability of each residual block of said combined sequence based on a position of the residual block in said combined sequence.

20. The one or more non-transitory computer-readable media of claim 17 wherein said adjusting said survival probabilities of said combined sequence occurs during backpropagation.
